(19) United States
(12) Patent Application Publication
(10) Pub. No.: US 2015/0115549 A1
(43) Pub. Date: Apr. 30, 2015

(54) MODULAR TOOL RETAINER

(71) Applicant: Guehring OHG, Albstadt (DE)

(72) Inventor: Bruno TEUSCH, Esslingen (DE)

(21) Appl. No.: 14/532,552

(22) Filed: Nov. 4, 2014

Related U.S. Application Data
(63) Continuation of application No. PCT/EP2013/061070, filed on May 29, 2013.

(30) Foreign Application Priority Data
Jun. 1, 2012 (DE) 10 2012 209 312.5

(51) Int. Cl. B23B 31/02; B23B 31/16

(52) U.S. Cl. CPC B23B 31/026; B23B 31/16287; B23B 2231/04; B23B 2231/24
USPC 279/4.06; 279/142; 279/5

(57) ABSTRACT

A modular tool retainer, comprising a main body extending along an axis of rotation and which is functionally divided into a shaft section for coupling to a machine tool spindle and a clamping section having a central accommodating bore for accommodating and clamping a cutting tool, which has a cutting head and at least one cutting edge, which is arranged concentrically to the main body and detachably fastened to the main body, and which is arranged at a predetermined axial and/or radial and/or angular position relative to the at least one cutting edge. The cutting head has a sleeve section, which extends the tool retainer and has a central accommodating bore arranged concentric to the central passage bore of the clamping section for accommodating and radially supporting a tool shaft part of the cutting tool protruding from the central accommodating bore of the clamping section.

The invention relates to a modular tool retainer according to the preamble to claim 1.

Such tool retainers are used in the pre- and/or final machining of varying functional surfaces on a work piece, possibly with a differing surface quality, in one operation or with one and the same clamp in a machine tool. The positional allocation of the machined functional surfaces on the work piece is here to lie in a narrow tolerance range. Such a tool retainer combined with a clamped cutting tool comprises a shank tool in the form of an incremental or final cutting tool, for example as required for the complete machining of cylinder heads, e.g., so as to design the main seat bore with the appropriately adjusted diameters for the inlet or outlet valve or the pre- and/or final machining of the valve seat, wherein the valve guide and valve seat bore are to be fabricated in one operation. The multiple functional surfaces to be formed in the area of the valve seat are subject to very narrow tolerances not just with respect to their angular position, but also in terms of their axial position. As a result, there exists a demand for a tool retainer that guarantees an extremely stable and precise true running of a clamped cutting tool.

DE 10 2006 016 290 A1 shows and describes a multipart shank tool for machining a first area having a smaller diameter, for example a valve guide bore to be precisely machined, and a second area having a larger area, for example a valve seat surface. For this purpose, the shank tool exhibits a tool retainer with a main body, which can be functionally divided into a shank section and clamping section, as well as a cutting head detachably fastened to the main body. The shank section is used to couple the tool retainer to a machine tool spindle, while the tool shank of a cutting tool, e.g., a multiple cutting edge reamer, is clamped into the clamping section via a hydraulic expansion mechanism. The cutting head sits on a cylindrical joining area of the clamping section, and upon actuation of the hydraulic expansion mechanism, is clamped synchronously with the centrally arranged cutting tool. The cutting head exhibits additional cutting edges. Therefore, the tool retainer on the one hand carries the centrally arranged cutting tool for machining the first area, and on the other the cutting head arranged concentrically to the cutting tool with additional cutting edges, which are arranged in a predetermined axial and/or radial and/or angular position relative to the cutting edges of the centrally arranged cutting tool.

The requirements placed on such tool retainers or such multistage shank tools are becoming tougher in several aspects. On the one hand, the buyers of such tool retainers and shank tools are demanding ever higher manufacturing accuracies, in particular ever narrower alignment and/or true running accuracies. On the other hand, increasingly heavier machinable materials are being used, so that the requirements placed on the stability of such tool retainers are also becoming more stringent. Finally, demands are calling for a tool retainer and shank tool that is easy to handle and flexible in use.

Therefore, the object of the invention is to create a modular tool retainer for a multistage shank tool of the kind described above, along with a corresponding shank tool, which simultaneously meet the criteria touched upon above in a form previously not achieved.

This object is achieved by a tool retainer having the features in claim 1, or by a shank tool having the features in claim 13. Advantageous or preferred further developments are the subject of the dependent claims.

Provided according to the invention is a modular tool retainer for a multistage shank tool that can be used as a finishing tool, and as an incremental or final machining tool, in which a cutting tool to be centrally clamped, for example a drill, a mill or a reamer, for machining a first area having a smaller diameter, along with a separate, sleeve-like cutting head, for example with a plurality of detachably fastened cutting inserts, for machining a second area having a larger diameter, are concentrically clamped in relation to each other.

To this end, the tool retainer initially exhibits an essentially rotationally symmetrical main body extending along a rotational axis. The main body can be functionally divided into a shank section for (directly or indirectly) coupling the tool retainer to a machine tool spindle, and a clamping section for accommodating and clamping the tool shank of a cutting tool to be clamped. The shank section of the main body can for this purpose be designed like a known HSK (hollow shank taper), SK (steep taper) MK (Morse taper) or cylindrical shank. The clamping section of the main body adjoins the shank section in an axial direction, and exhibits a central accommodating bore open on the tool side for accommodating the tool shank of a cutting tool to be clamped. For example, the tool shank can be clamped using a known hydraulic expansion mechanism.

The sleeve-like cutting head is arranged concentrically to the main body or a cutting tool held by the main body, and detachably fastened to the main body. According to the invention, the cutting head has a sleeve section, which extends the main body or tool retainer and has a central passage bore arranged concentrically to the central accommodating bore of the clamping section, which incorporates and radially supports the tool shank part protruding from the clamping section of a cutting tool clamped in the main body with a defined lateral clearance.

Because the sleeve section that envelops and radially supports the tool shank part protruding from the clamping section lies before the clamping section or main body in the tool advancing direction, radial support is generated at an axial distance from the clamping location provided by the clamping section. Depending on the length of the cutting head, a larger or smaller axial distance from the clamping section can be selected.

The sleeve section, which is situated upstream from the clamping section as viewed in the tool advancing direction, gives radial support to the tool shank part protruding from the clamping section, which helps reduce centrifugal force or clamping-related deviations in the longitudinal axis of the cutting tool from the rotational axis of the tool retainer, and thus diminishes true running errors. For this purpose, it is critical only that the passage bore of the sleeve section run concentrically to, i.e., be axially aligned with, the central accommodating bore of the clamping section. In this regard, it is sufficient that the central passage bore exhibit an inner diameter provided with a defined clearance fit only over a certain lengthwise section. Of course, the central passage bore can have an inner diameter provided with a defined clearance fit over its entire length. Shape- and/or clamping-related deviations in position between the longitudinal axis of the cutting tool and the rotational axis of the tool retainer along with deflections of the cutting tool owing to centrifugal forces can be significantly reduced or even precluded by having the inner diameter of the central passage bore lie within a narrow tolerance zone.

In order to obtain the highest possible coaxiality for the central passage bore in the sleeve section with the rotational axis of the tool retainer, and hence the highest possible concentricity for the central passage bore in the sleeve section relative to the accommodating bore in the clamping section, i.e., a defined clearance fit, the inner diameter range for the passage bore of the sleeve section critical for radial support can be machined to the tolerance required for the defined clearance fit in a state where the cutting head is secured to the main body, e.g., by means of a suitable reamer or grinding tool.

Another improvement is achieved by having the cutting head further exhibit a vernier adjustment device situated an axial distance away from the clamping section, in particular on its free end section facing away from the clamping section, which allows a vernier adjustment or correction of the radial position of the tool shank part protruding from the clamping section within the available lateral clearance or tolerance zone. Therefore, the vernier adjustment device makes it possible to correct a shape- or clamping-related positioning error that might cause the longitudinal axis of the cutting tool to deviate from the rotational axis of the tool retainer, so as to yield the most exact concentricity possible for the required high true running accuracy between the tool shank part of the cutting tool protruding from the clamping section and the cutting edge(s) provided on the cutting head.

In an embodiment that is structurally easy to realize and requires no greater operational outlay, the vernier adjustment device exhibits a plurality of setscrews arranged equidistantly around the rotational axis of the tool retainer, which each are supported against the sleeve section and press radially against the tool shank part protruding from the clamping section. For example, the setscrews can be locking screws with a hexagon socket, which are each screwed into a threaded bore penetrating through the sleeve wall of the sleeve section, and whose heads press radially against the tool shank part protruding from the clamping section. The equidistant distribution of setscrews makes it possible to minimize uneven mass distributions and resultant imbalances. In addition, imbalances can be manually and easily compensated without for this purpose having to remove balancing masses from the tool retainer, e.g., provide one or more balancing bores or the like, or secure balancing masses, e.g., balancing weights, to the tool retainer.

In this regard, it may be advantageous for the outer diameter of the cutting head to be incrementally tapered in the direction of the rotational axis toward the cutting tool. The free end section of the sleeve section on which the vernier adjustment device is positioned then forms an end section of the sleeve section with a diminished diameter.

This makes it possible to avoid deeper bores through the sleeve wall of the sleeve section, and the resultant unbalances. In addition, the opposing end section of the cutting head with a larger diameter can be advantageously used for securing the cutting head to the main body, while the at least one cutting edge, e.g., in the form of one or more detachably mounted replaceable or disposable cutting inserts, can be arranged in a central section of the cutting head.

The cutting head can be fastened to the main body through bolting. By way of an end face provided on its end section facing the main body, the cutting head can to this end be axially supported against an opposing end face of the main body. It is advantageous from a production standpoint that the opposing end faces on the cutting head and main body each be designed as planar annular surfaces lying in a radial plane. An especially stable connection between the cutting head and main body can be achieved by axially bolting the cutting head to the tool retainer with a plurality of clamping bolts equidistantly distributed around the rotational axis of the tool retainer. For example, the clamping bolts can each be guided through a bore on an enlarged-diameter annular flange of the cutting head, and screwed into an opposing threaded bore on the main body. In this way, the cutting head can be joined with the main body to form a multistage tool retainer that can be handled as a single piece.

Alternatively or additionally to bolting, the cutting head can be fastened to the main body via a hydraulic expansion mechanism based on the concept described in DE 10 2006 106 290 A1, for example, provided that the cutting head sits on the clamping section radially outside the clamping area of the hydraulic expansion mechanism as viewed in an axial direction. Through exposure to a pressure chamber of the hydraulic expansion mechanism, the hydraulic expansion mechanism can in this case be used to synchronously clamp the main body radially inwardly with the cutting tool held in the central accommodating bore and at the same time radially outwardly with the cutting head that sits radially outside on the clamping area of the clamping section enveloping the central receiving bore, so as to yield a multistage shank tool that can be handled as a single piece.

In particular, a configuration oriented toward the technical instruction imparted by DE 10 2006 016 290 A1 makes it possible to synchronously clamp the cutting tool and cutting head with the tool retainer in such a way that, while clamping the hydraulic expansion mechanism, the cutting edge(s) on the cutting tool and/or cutting head are maximally displaced to an extent lying within a prescribed tolerance zone or a range that can be corrected as needed via an additional, known vernier adjustment.

Based on the example of the technical instruction contained in DE 10 2006 016 290 A1, the tool retainer that clamps the cutting tool can be assembled with the cutting head sitting on the lengthwise area of the clamping section that envelops the central accommodating bore so as to yield a unit that can be handled as a single piece, in such a way that the expansion or elastic deformation of the cutting head remains within prescribed, very narrow limits in the process of clamping the cutting tool, as a result of which the clamping force of the hydraulic expansion mechanism is concentrated on the center, i.e., on the cutting tool. This ensures that the cutting tool can be aligned with the cutting head situated radially more outwardly on the cutting section to within a maximum true running accuracy.

At the same time, the clamping force for the cutting tool is increased, so that the hydraulic expansion mechanism carries over a larger axial length, which is further necessary for the true running between the cutting tool and cutting head. While clamping the cutting tool, this very same effect also ensures that the cutting edge(s) of the cutting head are not displaced by more than a permissible extent, which either already lies within the prescribed narrow tolerance zone, or within a range that can be corrected in a vernier adjustment of the cutting edges. This creates the preconditions for being able to change out the cutting tool and/or cutting head with simple hand movements, thereby yielding a modular, flexibly variable design in conjunction with assembling the tool retainer with the hydraulic expansion mechanism and the cutting head arranged on the clamping section.

With regard to the cutting edge(s) of the cutting tool, the vernier adjustment device provided at the free end section of the cutting head sleeve section makes it possible to limit a radial axial displacement of the cutting tool in relation to the rotational axis. Regardless of the above, the cutting head and/or cutting tool can each exhibit at least one cutting edge that can be subjected to a vernier adjustment in terms of its axial, radial and/or angular position relative to the rotational axis of the tool retainer.

The at least one cutting edge can be formed on a respective (replaceable or disposable) cutting insert detachably mounted on the cutting tool or cutting head, which in turn can be arranged on a cartridge situated on the cutting tool or cutting head so that it can be directly or indirectly subjected to a vernier adjustment. With regard to the indirect arrangement, the respective cutting insert can be secured to a cartridge whose axial and/or radial and/or angular position relative to the rotational axis of the tool retainer can be subjected to a vernier adjustment. For example, the cutting tool and/or cutting head can each have setscrews or driving wedges, which interact with the respective cutting insert or cartridge.

Further, the tool retainer according to the invention advantageously has an interior MQL (minimum quantity lubrication)-capable cooling lubricant supply system. The structural design and function of the latter is known, and thus requires no further explanation.

It was found that the structural design according to the invention for the tool retainer enables an extremely true-running accurate alignment of the cutting tool or cutting edge(s) on the cutting tool and/or cutting head while making it easy to change out the cutting tool and/or cutting head.

The structural design according to the invention makes a shank tool comprised of the tool retainer and cutting tool suitable for use as an incremental machining tool, in which the tool retainer and cutting head are used in a time-staggered manner, but with a precise relative positioning of the individual cutting edges.

The structural design according to the invention further makes it possible to build the shank tool as a modular tool, in which the main body is combined with various cutting tools and/or cutting heads. This yields a very flexibly usable tool retainer or very flexibly usable shank tool, with which a wide variety of machining tasks can be cost-effectively achieved.

Schematic drawings will be used below to explain a currently preferred embodiment of the invention in greater detail:

Shown on:

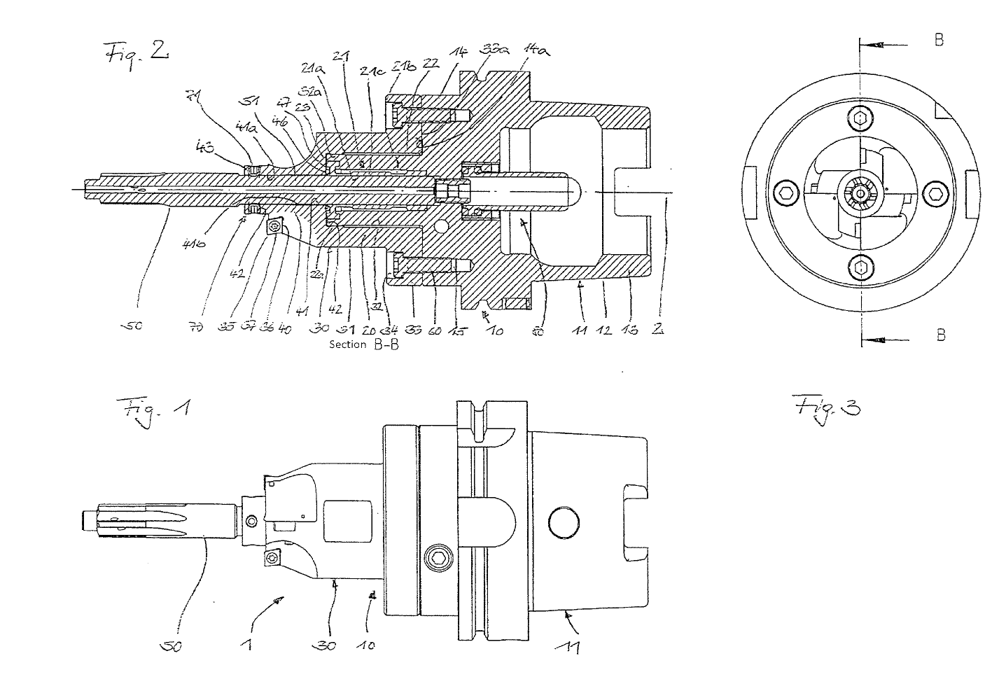

FIG. 1 is a side view of a multistage shank tool comprised of a tool retainer and a cutting tool clamped in the tool retainer;

FIG. 2 is a longitudinal sectional view of the shank tool; and

FIG. 3 is an axial top view of the shank tool.

FIGS. 1 to 3 provide schematic views of a multipart shank tool 1 for machining a tool. The multipart shank tool 1 involves a vernier adjustment tool, which can be used as an incremental tool for the complete machining of components, for example cylinder heads. Such tools are also known by the term finishing tool. The shank tool 1 depicted on FIGS. 1 to 3 is essentially comprised of a tool retainer 10, a cutting head 30 detachably fastened to the latter, and a cutting tool 50 centrally clamped in the tool retainer 10.

In the embodiment shown, the cutting tool 50 is a multiple cutting edge reamer with six cutting edges equidistantly distributed around the rotational axis 2. Alternatively, the cutting tool can be fitted with several replaceable or disposable cutting inserts that bear the cutting edges.

The tool retainer 10 exhibits an essentially rotationally symmetrical main body 11 extending along a rotational axis 2. In terms of structural design and function, the main body 11 corresponds to known hydraulic expansion chucks. The main body 11 is functionally divided into a shank section 12 and a clamping section 20, which extend along the rotational axis 2.

The shank section 12 is used to couple the tool retainer 10 or shank tool 1 to a machine tool spindle (not shown) or a tool module of a modularly constructed tool system (also not shown). To this end, the shank section 12 in the embodiment depicted has a known HST (hollow shank taper) shank 13, which is visible on FIGS. 1 and 2.

The clamping section 20 that axially elongates the shank section 12 exhibits a known hydraulic expansion mechanism 21 (see FIG. 2) with a central accommodating bore 21a open on the tool side for accommodating the tool shank 51 of the cutting tool 50. A pressure chamber marked with reference number 21b radially inwardly defines the central accommodating bore 21a used to accommodate a cylindrical tool shank 51 of the cutting tool 50 that has been ground to fit with the interposition of an elastically flexible separating wall 21c. The central accommodating bore 21a is fabricated in such a way that the tool shank 51 can be accommodated with a defined narrow clearance fit. How the hydraulic expansion mechanism 12 functions to clamp the cutting tool 50 is known, and need not be explained in any more detail.

Concentrically to the central accommodating bore 21a, the outer periphery of the clamping section 20 has an outer peripheral surface 22 which, at least in sections, in particular at least on one front end section 22a in the tool advancing direction, is fabricated in such a way relative to the rotational axis 2 as to observe a very narrowly set true running tolerance. This front end section 22a is used for radially positioning or concentrically arranging the cutting head 30 to be described later on the clamping section 20 of the main body 11.

The sleeve-like cutting head 30 whose diameter tapers in multiple stages in the tool advancing direction is detachably situated on the clamping section 20 of the main body 11 concentrically to the cutting tool 50 clamped in the clamping section 13. It is functionally divided into a joining section 31 that envelops the clamping section 20 and a sleeve section 40 that elongates the joining section 31 and is located upstream from the clamping section 13 in the tool advancing direction.

The outer periphery of the cutting head 30 is fitted with a plurality of replaceable or disposable cutting inserts 35, which each are located in a pocket-like recess 36 and detachably fastened by means of a clamping bolt 37. The cutting inserts 35 can be arranged on several diameters, and have axially and/or radially acting cutting edges, for example which are used to machine a valve seat ring or a bore in the cylinder head provided for this purpose. Of course, the cutting edges can also be inclined relative to the rotational axis at various angles to be precisely observed, for example as required when finishing valve seat rings.

In particular, FIG. 1 shows that the outer periphery of the cutting inserts 35 is situated on a lengthwise section of the sleeve section 40 that has a tapering diameter, in particular axially between the front end section of the sleeve section 40 and joining section 31 of the cutting head 30. This arrangement yields an unimpeded accessibility to an adjustment device 70 that will be described later, as well as to clamping bolts 60 that will also described later.

As an alternative to the arrangement evident from FIG. 1, the replaceable or disposable cutting inserts 35 located directly on the cutting head 30 can each be situated so as to be adjustable in terms of their radial and/or axial angular position relative to the rotational axis 2 (in a manner not shown in any greater detail). In addition, replaceable or disposable cutting inserts 35 can each be secured by way of a cartridge (not shown) indirectly to the cutting head 30, which in terms of its axial and/or radial and/or angular position relative to the rotational axis of the tool retainer 10 is secured to the latter so that it can be subjected to a vernier adjustment. For example, adjustability is achieved for the replaceable or disposable cutting inserts 35 or the cartridge by means of one or more setscrews or driving wedges supported against the cutting head 30, which interact with the respective cutting insert 35 or cartridge.

As an alternative to the concepts described above, the cutting edges of the cutting head 30 can be incorporated directly on the cutting head 30 based on the example of the cutting tool 50.

The joining section 31 has a central accommodating bore open on the main body side, at least sections of which, in particular the section bordering the floor of the accommodating bore 32, exhibit a cylindrical inner peripheral surface 32a, which in terms of the rotational axis 2 is designed in such a way as to observe a very narrowly set true running tolerance. The cylindrical lengthwise sections 32a, 22a of the central accommodating bore 32 of the joining section 40 and the clamping section 20 respectively fabricated at a narrowly set true running tolerance can be used to position the cutting head 30 on the clamping section 20 of the main body 11 with a narrowly defined clearance fit coaxial to the rotational axis 2 or concentrically to the cutting tool 50 clamped into the clamping section 20.

In order to axially position and fasten the cutting head 30 to the main body 11, the outer periphery of the joining section 31 exhibits a flange-like radial projection 33, which on the main body side exhibits an end face 33a, which abuts against an opposing end face 14a of a radial shoulder 14 of the main body 11. The opposing end faces 33a, 14a on the cutting head 30 and main body 11 are each designed as planar annular surfaces lying in a radial plane. In the embodiment shown, the cutting head 30 is axially bolted to the main body 11 by a plurality of clamping bolts 60 distributed equidistantly around the rotational axis 2. The clamping bolts 60 are each supported on the cutting head side in an axial stepped bore 34 in the radial projection 33 of the cutting head 30, and screwed into an opposing threaded bore 15 on the main body side, as shown in detail on FIG. 2. As a result, the cutting head 30 is connected with the main body 11 in a torque-proof, but detachable manner.

The axial depth of the central accommodating bore 32 of the joining section 31 is slightly larger than the axial length of the clamping section 20 of the main body 11. Therefore, a radial end face 42 located at the transition from the central accommodating bore 32 in the joining section 31 to a central passage bore 41 in the sleeve section 40 lies at a slight distance from the opposing end face 23 of the clamping section 20 of the main body 11. The resultant joining gap between the end faces 23 and 42 lying axially opposite each other takes place via an O-ring seal 46, which is situated in an annular groove 47 incorporated at the end face 23 of the clamping section 20.

Alternatively or additionally to bolting the cutting head 30 to the main body 11 with the clamping bolts 60, the cutting head 30 can be fastened based on the concept described in DE 10 2006 016 290 A1 via the hydraulic expansion mechanism 21 integrated into the clamping section 20. Given a corresponding structural configuration of the clamping section 20, exposing the pressure chamber 21b of the hydraulic expansion mechanism 21 to a pressure can result in the main body becoming synchronously clamped radially inwardly with the cutting tool 50 held in the central accommodating bore 21a and radially outwardly with the cutting head 30 sitting on the clamping section 20 to yield a multistage shank tool 1 that can be handled as a single piece.

As depicted on FIG. 2, the sleeve section 40 exhibits a centrally running passage bore 41, which thanks to the concentric arrangement of the cutting head 30 on the main body 11 is situated concentrically to the central accommodating bore 21a in the clamping section 20, and envelops the tool shank part of the cutting tool 50 clamped in the clamping section 20 that protrudes from the clamping section 20 with a defined lateral clearance. The sleeve section 40 is situated upstream from the clamping section 20 as viewed in the tool advancing direction, and gives the tool shank part protruding from the clamping section 20 radial support, which helps reduce centrifugal force or clamping-related deviations in the longitudinal axis of the cutting tool 50 from the rotational axis 2 of the tool retainer 1, and thus diminishes true running errors.

In the embodiment shown, the central passage bore 41 is designed as a kind of stepped bore that exhibits an inner diameter fabricated with a defined clearance fit over a specific length only on its front end section 41a facing away from the main body 11. The length section 41b of the central passage bore 41 of the sleeve section 40 situated between this crucial length section 41a, the inner diameter of which is fabricated with a defined clearance fit, and the central accommodating bore 21a of the clamping section 20 has a slightly larger inner diameter than the crucial length section 41a. As an alternative thereto, however, the central passage bore 41 can have an inner diameter fabricated with a defined clearance fit over its entire length, i.e., the crucial length section can extend over the entire length of the central passage bore 41. In any event, the inner diameter of the crucial length section 41a of the central passage bore 41 lies in a narrow tolerance zone, so as to reduce or preclude shape and/or clamping-related deviations in position between the longitudinal axis of the cutting tool 50 and the rotational axis 2 of the tool retainer 1 along with deflections of the cutting tool 50 relative to the rotational axis 2 owing to centrifugal forces.

In order to achieve the highest possible concentricity for the crucial length section 41a of the passage bore that radially positions the cutting tool 50 in relation to the rotational axis 2 of the tool retainer 1, and hence to the accommodating bore 21a in the clamping section 20, the inner diameter of this crucial length section 41a of the passage bore 41 can be machined to the tolerance required for the narrow clearance fit by means of a suitable reamer or grinding tool in a state in which the cutting head 30 is secured to the main body 11.

As evident from FIG. 1, the outer diameter of the cutting head 30 is incrementally tapered away from the radial projection 33 in the direction of the rotational axis 2 toward the cutting tool 50. In the embodiment shown, the front end section of the sleeve section 40 facing away from the main body 11 is additionally provided with a vernier adjustment device 70, which allows a vernier adjustable positional correction of the cutting tool 50 within the available tolerance zone. In particular, the vernier adjustment device 70 in the embodiment shown exhibits a plurality of setscrews 71, in particular locking screws with a hexagon socket, which are provided on the front end section of the sleeve section 40 facing away from the clamping section 20. FIG. 2 depicts two of these setscrews 71. The plurality of setscrews 71 equidistantly distributed around the rotational axis 2 of the tool retainer 10 are each screwed into a threaded bore 43 penetrating through the sleeve wall 42 of the sleeve section 40, and their heads respectively press radially against the tool shank part of the cutting tool 50 protruding from the clamping section 20. As evident from FIG. 1, the vernier adjustment device 70 comprised of the setscrews 71 hence provides the capacity of making a vernier adjustment at a defined axial distance from the location where the tool shank is clamped into the clamping section 20 of the tool retainer 10 in order to correct the radial position of the tool shank part of the cutting tool 50 protruding from the clamping section 20.

The tool holder 2 or shank tool 1 further has an interior MQL (minimum quantity lubrication)-capable cooling lubricant supply system (not described in any greater detail) in the form of a known cooling lubricant transfer unit 80.

The structural design described above makes it possible to use the cutting tool 50, cutting head 30 and main body 11 as components in building up a modular shank tool 1, which is characterized by a high true running accuracy for the cutting edges arranged on the cutting tool 50 and on the cutting head 30.

1. A modular tool retainer with a main body extending along a rotational axis, which is functionally divided into a shank section for coupling to a machine tool spindle and a clamping section with a central accommodating bore for accommodating and clamping a cutting tool exhibiting at least one cutting edge, and a cutting head with at least one cutting edge that is arranged concentrically to the main body and detachably fastened to the main body, and also situated in a predetermined axial and/or radial and/or angular position relative to the at least one cutting edge of the cutting tool, characterized in that
the cutting head exhibits a sleeve section that elongates the tool retainer and has a central accommodating bore arranged concentrically to the central passage bore of the clamping section for accommodating and radially supporting a tool shank part of the cutting tool protruding from the central accommodating bore of the clamping section.

2. The tool retainer according to claim 1, wherein the central passage bore exhibits an inner diameter fabricated with a defined clearance fit, at least over a certain lengthwise section.

3. The tool retainer according to claim 1, wherein the cutting head exhibits a vernier adjustment device at an axial distance from the clamping section for making a vernier adjustment to the radial position of the tool shank part protruding from the clamping section.

4. The tool retainer according to claim 3, wherein the vernier adjustment device exhibits a plurality of setscrews equidistantly arranged around the rotational axis of the tool retainer, which each are supported against the sleeve section and press radially against the tool shank part protruding from the clamping section.

5. The tool retainer according to claim 1, wherein the cutting head is bolted to the main body.

6. The tool retainer according to claim 1, wherein, by way of an end face provided on its end section facing the main body, the cutting head is axially supported against an opposing end face of the main body.

7. The tool retainer according to claim 6, wherein the opposing end faces are each planar annular surfaces lying in a radial plane.

8. The tool retainer according to claim 5, wherein the cutting head is axially bolted to the main body by a plurality of clamping bolts equidistantly distributed around the rotational axis of the tool retainer.

9. The tool retainer according to claim 1, wherein the outer diameter of the cutting head tapers in the direction of the rotational axis toward the cutting tool.

10. The tool retainer according to claim 1, wherein a hydraulic expansion mechanism is integrated into the clamping section for clamping a tool shank part accommodated in the clamping section.

11. The tool retainer according to claim 1, wherein the cutting head and/or the cutting tool each exhibit at least one cutting edge whose axial, radial and/or angular position relative to the rotational axis of the tool retainer can be subjected to a vernier adjustment.

12. The tool retainer according to claim 1, characterized by an interior cooling lubricant supply.

13. A shank tool comprising a tool retainer as recited in claim 1 and a cutting tool held in the tool retainer.
